(19) United States
(12) Patent Application Publication
(10) Pub. No.: US 2025/0321119 A1
(43) Pub. Date: Oct. 16, 2025

(54) VALIDATION OF MAPPING OUTPUT

(71) Applicant: TOYOTA JIDOSHA KABUSHIKI KAISHA, Toyota-Shi (JP)

(72) Inventors: YUCONG LIN, Ann Arbor, MI (US); Hai Jin, Fremont, CA (US)

(21) Appl. No.: 18/632,158

(22) Filed: Apr. 10, 2024

(51) Int. Cl. G01C 21/00; G06T 7/579

(52) U.S. Cl. CPC G01C 21/387; G01C 21/3833; G01C 21/3867; G06T 7/579; G06T 2200/24; G06T 2207/20081; G06T 2207/20132; G06T 2207/30252

(57) ABSTRACT

Systems and methods are provided for verification of the mapping output while accounting for the large amount of data associated with a full geometry map. For example, the system may generate the geometry map of an environment where a vehicle is located and automatically identify a defective area of the geometry map. The defective area may, for example, be identified using a machine learning model to detect the defective area with respect to a threshold or confidence value. The system can receive a bounding box from at least one user device that identifies an adjustment to the defective area of the geometry map. Using the bounding box, the system can crop the defective area of the geometry map and initiate an action based on the adjustment to the defective area of the geometry map.

### TECHNICAL FIELD

The present disclosure relates generally to validating mapping output, and in particular, some implementations may relate to receiving a vehicle's sensor data that is used to map an environment with an external mapping system and providing a mapping output to a user interface for validation of the mapping output.

### DESCRIPTION OF RELATED ART

Imaging devices can generate digital image data of an environment to help create a digital representation of the environment. For example, a system may mount an imaging device to a vehicle in motion within the environment. Image data generated by the imaging device can be used to generate a map of the vehicle's surroundings and determine the vehicle's location within its environment.

In some instances, Simultaneous Localization and Mapping (SLAM) techniques may be applied to the image data to allow the vehicle to build a map of an unknown environment while simultaneously keeping track of its current location in the environment. In general, SLAM techniques may use data from different types of sensors (in addition to or in lieu of image data from cameras) to localize the mobile platform(s) and map the features of the environment. For example, other data from cameras and/or data from odometers, gyroscopes, and depth sensors may be used. In some instances, traditional SLAM techniques may generate mapping output with errors that can affect the accuracy of the resulting map.

### BRIEF SUMMARY OF THE DISCLOSURE

According to various embodiments of the disclosed technology, a method for validating a geometry/output map is provided. The map may originate from images captured by an autonomous or semi-autonomous vehicle as it operates in an environment and encounters various landmarks. The method may comprise, for example, generating, using an internal mapping system of the vehicle and an external mapping system of the vehicle, a geometry map of an environment where the vehicle is located. The method may automatically identify, using a machine learning model, a defective area of the geometry map and provide, via a user interface at a user device, the geometry map and the defective area. The method may receive a bounding box from at least one user device of the user devices. In some examples, the bounding box identifies an adjustment to the defective area of the geometry map. The method may crop the defective area of the geometry map based on the bounding box and initiate an action based on the adjustment to the defective area of the geometry map.

In some examples, the action comprises retrieving sensor data from a second vehicle associated with the environment where the first vehicle is located.

In some examples, the action comprises retraining the machine learning model based on receiving the bounding box from the at least one user device.

In some examples, the defective area is drawn as a polygon overlaid on the geometry map. Both the polygon and the geometry map may be provided to the user interface. In some examples, the defective area is a three-dimensional object and the polygon is a two-dimensional object.

In some examples, the geometry map is drawn with a first set of polygons and the defective area is drawn with a second polygon that differs from the first set of polygons.

In some examples, the bounding box is a first bounding box received from the user device. The first bounding box may be received concurrently with a second bounding box from a second user device.

In some examples, the internal mapping system of the vehicle receives sensor data from sensors in the vehicle used to generate the geometry map of the environment.

In some examples, the external mapping system of the vehicle is a Simultaneous Localization and Mapping (SLAM) system.

In some examples, the machine learning model is a classifier implemented by a supervised machine learning model.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example vehicle with which some embodiments of systems and methods disclosed herein may be implemented.

FIG. 2 illustrates an example architecture for the validation of mapping output, in accordance with some embodiments of the systems and methods described herein.

FIG. 3 is an example process between a vehicle, mapping system, validation system, and user interface, in accordance with some embodiments of the systems and methods described herein.

FIG. 4 illustrates an example user interface showing a mapping output, in accordance with some embodiments of the systems and methods described herein.

FIG. 5 illustrates an example user interface showing a mapping output, in accordance with some embodiments of the systems and methods described herein.

FIG. 6 illustrates an example user interface showing a mapping output, in accordance with some embodiments of the systems and methods described herein.

FIG. 7 illustrates an example user interface showing a mapping output, in accordance with some embodiments of the systems and methods described herein.

FIG. 8 illustrates an example user interface showing a bounding box with mapping output, in accordance with some embodiments of the systems and methods described herein.

FIG. 9 illustrates a process for validation of mapping output, in accordance with some embodiments of the systems and methods described herein.

FIG. 10 is an example computing component that may be used to implement various features of embodiments described in the present disclosure.

The figures are not exhaustive and do not limit the present disclosure to the precise form disclosed.

### DETAILED DESCRIPTION

Vehicle sensors collect various information about the vehicle itself and surrounding environment in order to generate a geometry map of the environment surrounding the vehicle. One method of creating the geometry map is through the use of a Simultaneous Localization and Mapping or “SLAM” system. The SLAM technique is a process of mapping an area while keeping track of the location of the vehicle within that area. In some examples, the SLAM process can generate the geometry map (e.g., offline or remotely at an external SLAM system) and the vehicle can use the map to perform localization, including for example, determining its current location and the location of landmarks within the environment. In some examples, the vehicle may also use the map to navigate to a new/second location. The vehicle can use the map generated from the SLAM process to digitize large areas around the vehicle so that the vehicle can autonomously determine its current location, or the location of a landmark adjacent to the vehicle, and navigate to the new location.

In some traditional systems, the geometry maps may include defective areas where the map is not truly accurate. When the vehicle is using the geometry map to navigate the area and detect landmarks, the defective areas of the map may cause safety issues with operation of the vehicle and provide inaccurate data for the system. However, the geometry maps are so large, it is difficult to transmit the entire geometry map for any quality check or adjustment process.

Embodiments of the systems and methods disclosed herein can provide verification of the mapping output while accounting for the large amount of data associated with a full geometry map. For example, the system may generate the geometry map of an environment where the vehicle is located and automatically identify a defective area of the geometry map. The defective area may, for example, be identified using a machine learning model to detect the defective area with respect to a threshold or confidence value. The geometry map and defective area may be provided to a user interface at a user device where, for example, the user device may interact with the geometry map and defective area. In some cases, users may interact with the geometry map and defective area using the user interface at the user devices. The system can receive a bounding box from at least one user device that identifies an adjustment to the defective area of the geometry map. Using the bounding box, the system can crop the defective area of the geometry map and initiate an action based on the adjustment to the defective area of the geometry map.

Technical improvements are described throughout the disclosure. For example, by identifying the bounding box associated with an adjustment to the defective area of the geometry map, the system is able to crop the defective area of the geometry map to generate cropped data. This may identify less data (e.g., within the bounding box associated with the cropped data). The less amount of data may be transmitted between the system and the user devices, which in turn can create less data transmitted overall via the communication network to reserve additional bandwidth for other transmissions. Additionally, the identification and adjustment to the geometry map may provide for better navigation and safety, as well as improved digital mapping for the vehicle in the environment.

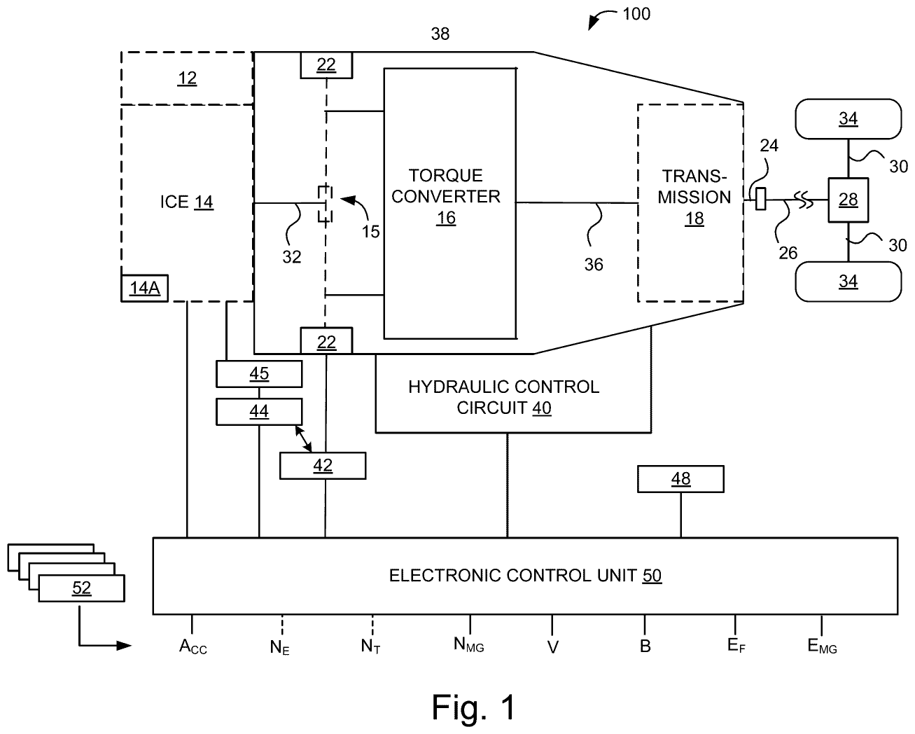

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for validation of mapping output can be implemented in other types of vehicle including gasoline-or diesel-powered vehicles, fuel-cell vehicles, electric vehicles, or other vehicles.

FIG. 1 illustrates a drive system of a vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 100 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 100 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 100 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

n the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14 +MG 12) efficiency, acceleration, ACC, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

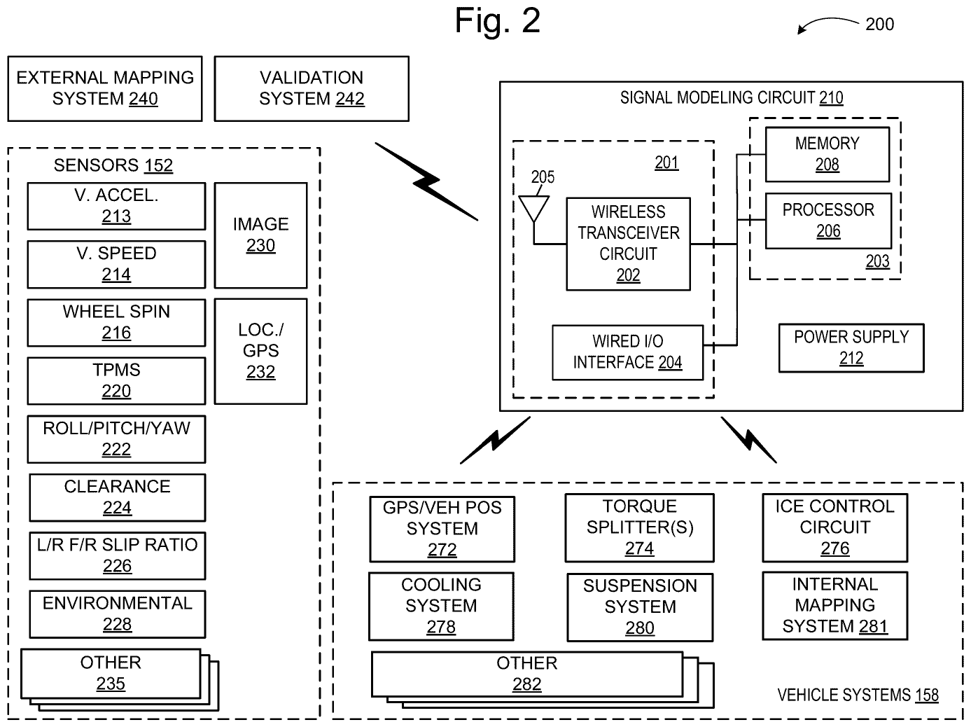

FIG. 2 illustrates an example architecture for the validation of mapping output, in accordance with some embodiments of the systems and methods described herein. In example 200, the vehicle includes signal modeling circuit 210, a plurality of sensors 152 and a plurality of vehicle systems 158. Sensors 152 and vehicle systems 158 can communicate with signal modeling circuit 210 via a wired or wireless communication interface. Although sensors 152 and vehicle systems 158 are depicted as communicating with signal modeling circuit 210, they can also communicate with each other as well as with other vehicle systems. Signal modeling circuit 210 can be implemented as an ECU or as part of an ECU such as, for example electronic control unit 50. In other embodiments, signal modeling circuit 210 can be implemented independently of the ECU.

Signal modeling circuit 210 in this example includes a communication circuit 201, a decision circuit 203 (including a processor 206 and memory 208 in this example) and a power supply 212. Components of signal modeling circuit 210 are illustrated as communicating with each other via a data bus, although other interfaces can be included.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208, can be made up of one or more modules of one or more different types of memory, and may be configured to store data and other information as well as operational instructions that may be used by the processor 206 to signal modeling circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up signal modeling circuit 210.

Communication circuit 201 either or both a wireless transceiver circuit 202 with an associated antenna 205 and a wired I/O interface 204 with an associated hardwired data port (not illustrated). As this example illustrates, communications with signal modeling circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by signal modeling circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on vehicle 100 with which the system illustrated in example 200 is implemented. In the illustrated example, sensors 152 include vehicle acceleration sensors 213, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, environmental sensors 228 (e.g., to detect salinity or other environmental conditions), image sensors 230 (e.g., to capture images in the environment), and location sensors 232 (e.g., to capture locations of the vehicle). Additional sensors 235 can also be included as may be appropriate for a given implementation of signal modeling circuit 210.

During operation at the vehicle, signal modeling circuit 210 can receive information from various vehicle sensors. Communication circuit 201 can be used to transmit and receive information between signal modeling circuit 210 and sensors 152, and signal modeling circuit 210 and vehicle systems 158. Also, sensors 152 may communicate with vehicle systems 158 directly or indirectly (e.g., via communication circuit 201 or otherwise).

In some embodiments, communication circuit 201 can be configured to receive data and other information from sensors 152 that is used in generate sensor-based modeling of landmarks in an environment of the vehicle. Illustrative examples of sensors that are coupled with vehicle components and a shared electronic control unit are acceleration sensors 213, vehicle speed sensors 214, wheelspin sensors 216, tire pressure monitoring system (TPMS) 220, accelerometers 222, vehicle clearance sensors 224, slip ratio sensors 226, environmental sensors 228, image sensor 230, and location sensor 232.

Image sensor 230 is configured to generate image data of the environment surrounding the vehicle. Image sensor 230 may comprise a camera. The image data may comprise images of the visual environment surrounding the vehicle.

Location sensor 232 is configured to generate location data of landmarks in the environment surrounding the vehicle or location data of the vehicle itself. Location sensor 232 may comprise a Global Positioning System (GPS) sensor in communication with GPS satellites to receive geographic location information. The location data may comprise precise coordinates (e.g., latitude, longitude, and altitude) of the vehicle's current position on the Earth's surface.

Vehicle systems 158 can include any of a number of different vehicle components or subsystems used to control or monitor various aspects of the vehicle and its performance. In this example, the vehicle systems 158 include a global navigation satellite system (GNSS), GPS, or other vehicle positioning system 272; torque splitters 274 that can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, or an adjustable-damping suspension system; internal mapping system 281; and other vehicle systems 282.

In some examples, internal mapping system 281 may transmit communications to external mapping system 240, which can be implemented outside of the vehicle. Internal mapping system 281, which can be implemented as a component of the vehicle, may receive communications from external mapping system 240. The communications from internal mapping system 281 that are transmitted to external mapping system 240 may comprise sensor data and internal mapping system 281 may receive the updated geometry map from external mapping system 240.

Internal mapping system 281 may transmit image data and location data to external mapping system 240. External mapping system 240 may comprise a Simultaneous Localization and Mapping or “SLAM” system to implement the SLAM technique. The SLAM technique is a process of mapping an area while keeping track of the location of the vehicle within that area. In some examples, the SLAM process can rely on both/either internal mapping system 281 and external mapping system 240 to generate a geometry map and the vehicle can use the map to perform localization, including for example, determining its current location and the location of landmarks. In some examples, the vehicle may also use the map to navigate to a new/second location. The vehicle can use the map generated from the SLAM process to digitize large areas around the vehicle so that the vehicle can autonomously determine its current location, or the location of a landmark adjacent to the vehicle, and navigate to a new location.

In some examples, external mapping system 240 can extract features from the image, such as lane markers, road boundaries, road signs, traffic lights, and other landmarks/features of the environment. In this instance, internal mapping system 281 may not need to transmit image data and location data to external mapping system 240. Rather, internal mapping system 281 may transmit the image and external mapping system 240 can extract the image data and location data locally, then continue to implement the SLAM technique, as discussed herein.

In some examples, external mapping system 240 may transmit the geometry map to validation system 242. Validation system 242 is configured to provide the geometry map to a user interface of a user device. Validation system 242 is also configured to receive a bounding box, validation, or other feedback from the user device via the user interface. The bounding box may identify an adjustment to a defective area of the geometry map, which may ultimately be used to improve the geometry map for the vehicle.

In some examples, multiple bounding boxes are generated by a set of user devices. The user devices may access the geometry map and generate the bounding boxes on separate user devices each with a user interface. The bounding boxes may be generated and/or transmitted concurrently to validation system 242 for further review.

In some examples, internal mapping system 281 may receive the image data from image sensor 230 and location data from location sensor 232 and transmit the sensor data to external mapping system 240. External mapping system 240 may be configured to determine a landmark in the environment through a data association process that utilizes the sensor data. In some examples, external mapping system 240 may model a SLAM system that builds a geometry map and localizes a vehicle in the geometry map. The system may build the geometry map and localize the vehicle simultaneously. External mapping system 240 can generate the geometry map and transmit it back to the vehicle (e.g., internal mapping system 281), which can allow the vehicle to map out unknown environments and carry out tasks such as path planning and obstacle avoidance.

In some examples, external mapping system 240 may generate a covariance of the location of the landmark using the mapping process. The covariance may be the uncertainty associated with the estimated location of the landmarks in the environment. External mapping system 240 may generate a covariance matrix to represent the uncertainty of the location of the landmark. In some examples, the location of the landmark may be based on data generated by the location sensor, image sensor, or other sensors on the vehicle. The covariance of the location of the landmark measures sensor noise and errors in motion (e.g., while the vehicle is in motion). The covariance matrix can quantify the uncertainty by describing the spread or dispersion of estimated quantities.

To rely on both the location sensor and the image sensor, external mapping system 240 may synchronize image data and location data using data association techniques. For example, the timestamps generated with these sensor data values can help align the sensor data and generate the geometry map using the sensor data. This alignment can help external mapping system 240 fuse data from multiple sensors, such as cameras, LIDARs, and IMUs (Inertial Measurement Units), to estimate the vehicle's position and map the environment accurately.

The output of external mapping system 240 may be provided to validation system 242. Validation system 242 may implement a machine learning model to classify or identify any defective areas of the geometry map that was generated by external mapping system 240. For example, during training of the machine learning model, each small area of a larger map (e.g., in relation to a threshold difference between the two sizes of maps) may be manually labeled as defective or not defective areas (e.g., good/bad, numerical value, etc.). Features from the small areas (such GPS factors residuals) may be labelled accordingly as defective or not defective areas. Those labelled features may be used as input for supervised classifier such as a Decision Tree or a Support Vector Machine. During inference, the trained classifier may be used to predict the label of corresponding features of small areas of a new map.

The small area of a larger map may correspond with the H3 geospatial indexing system, which is a discrete global grid system. The discrete global grid system may comprise, for example, a multi-precision hexagonal tiling of the sphere with hierarchical indexes. The hexagonal grid system (e.g., the larger map) may be created on the planar faces of a sphere-circumscribed icosahedron, and the grid cells (e.g., the smaller areas) may be projected to the surface of the sphere. The projection may implement various processes, including for example, an inverse face-centered polyhedral gnomonic projection. The coordinate reference system (CRS) may correspond with spherical coordinates with the WGS84/EPSG:4326 authalic radius. The H3 grid may be constructed on the icosahedron by recursively creating increasingly higher precision hexagon grids until a predetermined resolution is achieved.

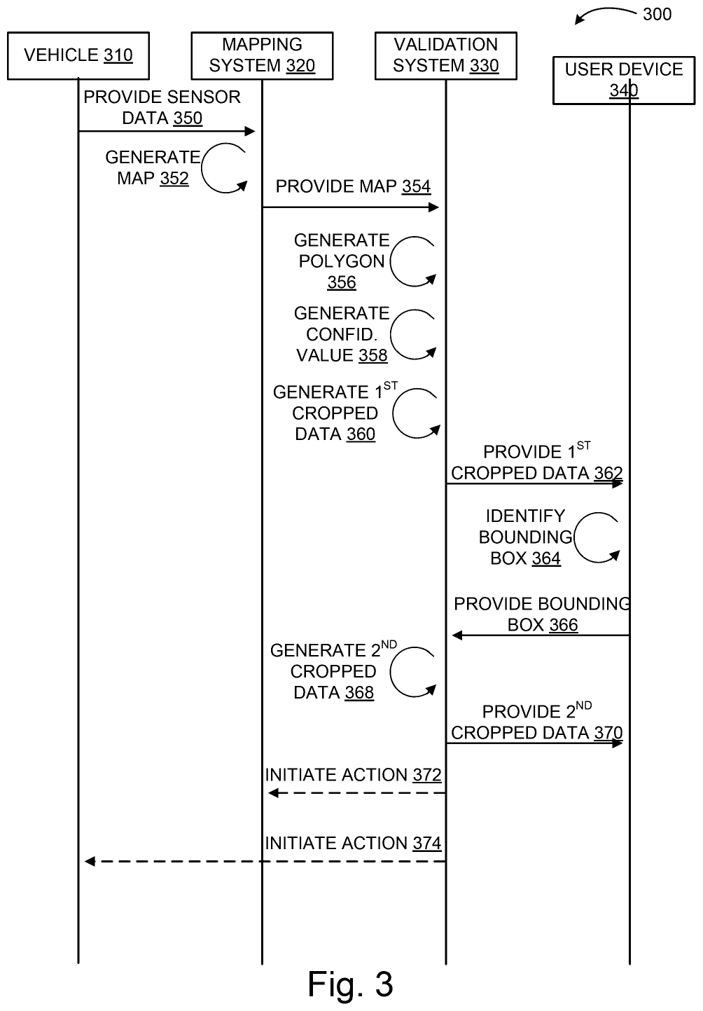

In some examples, the defective area may be identified by the machine learning model as corresponding with a landmark with a confidence value that exceeds a threshold value (e.g., corresponding with an inaccuracy or defectiveness of the geometry map). Various illustrations of the confidence value that exceeding the threshold value are shown in FIGS. 3-5 and described herein.

The geometry map and the defective area may be provided to a user interface at a user device. A bounding box may be received via the user interface to identify an adjustment to the defective area of the geometry map. In some examples, a human user may identify the dimensions of the bounding box.

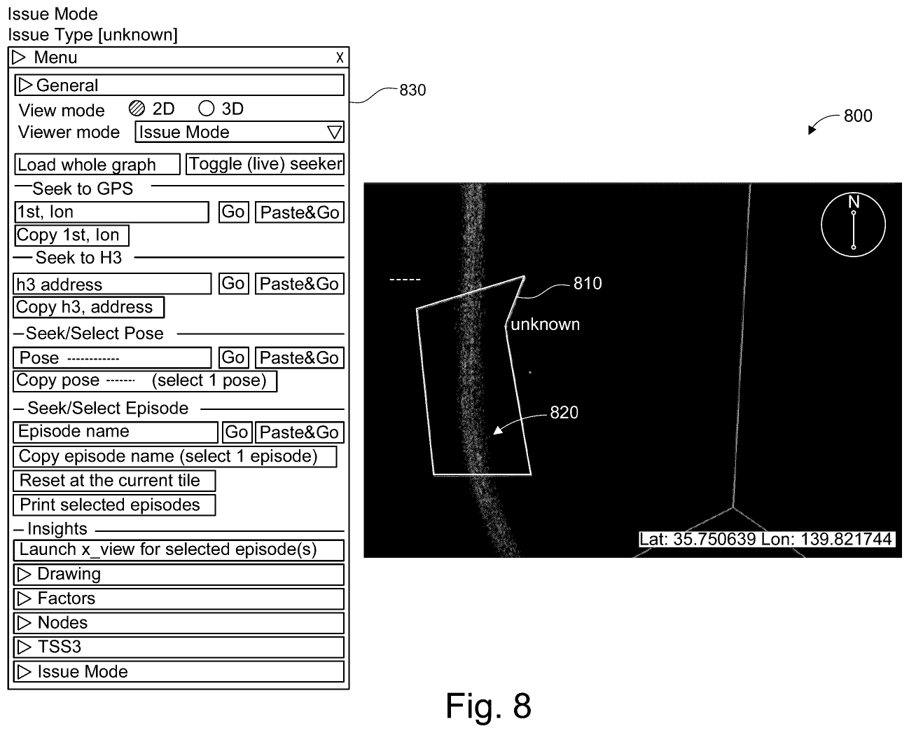

In some examples, the bounding box is generated by the user device using user interface tools to manually draw the bounding box on the geometry map. The user can activate the tool by selecting the tool at the user interface and selecting/clicking on digital locations/points around the map. The bounding box may be enclosed/completed when the user selects the first location/point to close the bounding box. The bounding box may correspond with a polygon. Additional features of the bounding box and tools are provided in FIG. 8.

The bounding box or corresponding adjustment to the defective area of the geometry map may be provided back to the validation system 242 as an update/adjustment to the geometry map or machine learning model. For example, the action may comprise retrieving additional sensor data from a second vehicle associated with the environment where the first vehicle is located. The additional sensor data may comprise image data that can show a particular portion of the environment in additional detail or from alternative angles. The additional sensor data may be used to update the geometry map for the environment.

In some examples, the bounding box or corresponding adjustment to the defective area of the geometry map may initiate other actions. For example, the action may include providing the adjustment to the defective area of the geometry map back to the validation system 242. Validation system 242 may update the machine learning model based on receiving the bounding box from the at least one user device. For example, when the bounding box is received from the user interface, the existence of the bounding box may identify a defect with the map (e.g., the confidence score exceeds a threshold value associated with the machine learning model). Receiving the bounding box may initiate a retraining of the machine learning model to provide more accurate geometry maps that detect/classify landmarks in the environment.

FIG. 3 is an example process between a vehicle, mapping system, validation system, and user interface, in accordance with some embodiments of the systems and methods described herein. In example 300, vehicle 310, mapping system 320, validation system 330, and user interface 340 are shown. In some examples, validation system 330 may be implemented at a user device that also implements user interface 340.

At block 350, vehicle 310 may provide sensor data to mapping system 320. For example, vehicle 310 may be communicatively connected with an imaging device to capture images (as image data) of the environment while the vehicle is in motion. Multiple sensors may generate multiple types of data at vehicle 310, such as cameras, LIDARs, and IMUs (Inertial Measurement Units). Vehicle 310 may provide the sensor data that it captures at the vehicle to mapping system 320 via a communication network.

At block 352, mapping system 320 may generate the geometry map. In some instances, mapping system 320 may implement Simultaneous Localization and Mapping (SLAM) techniques. The SLAM techniques may use the sensor data generated by vehicle 310 to build a map of the environment while simultaneously allowing the vehicle to keep track of its current location in the environment. In some examples, the sensor data may be captured by an autonomous or semi-autonomous vehicle as it operates in an environment and encounters various landmarks within its environment.

In some examples, mapping system 320 may be configured to determine a landmark in the environment through a data association process that utilizes the sensor data. For example, mapping system 320 may generate a covariance of the location of the landmark using the mapping process. The covariance may be the uncertainty associated with the estimated location of the landmarks in the environment. In some examples, the location of the landmark may be based on data generated by the location sensor, image sensor, or other sensors on the vehicle. The covariance of the location of the landmark measures sensor noise and errors in motion (e.g., while the vehicle is in motion). The covariance matrix can quantify the uncertainty by describing the spread or dispersion of estimated quantities.

To rely on both the location sensor and the image sensor, mapping system 320 may synchronize sensor data collected by different sensors (e.g., image data and location data) using data association techniques. For example, the timestamps generated with these sensor data values can help align the sensor data and generate the geometry map using the sensor data. This alignment can help mapping system 320 fuse data from multiple sensors, such as cameras, LIDARs, and IMUs (Inertial Measurement Units), to estimate the vehicle's position and map the environment accurately.

At block 354, mapping system 320 may provide the geometry map to validation system 330. Validation system 330 may analyze/store the geometry map for further processing.

At block 356, validation system 330 may generate polygons associated with the geometry map. In some examples, validation system 330 may identify grouped areas of the map using polygons. Each polygon may, for example, identify a small area of a larger map corresponding with the H3 geospatial indexing system, which is a discrete global grid system. The discrete global grid system may comprise, for example, a multi-precision hexagonal/polygon tiling of the sphere with hierarchical indexes. The hexagonal grid system (e.g., the larger map) may be created on the planar faces of a sphere-circumscribed icosahedron, and the grid cells (e.g., the smaller areas) may be projected to the surface of the sphere. The projection may implement various processes, including for example, an inverse face-centered polyhedral gnomonic projection. The coordinate reference system (CRS) may correspond with spherical coordinates with the WGS84/EPSG:4326 authalic radius. The H3 grid may be constructed on the icosahedron by recursively creating increasingly higher precision hexagon grids until a predetermined resolution is achieved.

At block 358, validation system 330 may generate confidence values associated with the polygons using a machine learning model. For example, during training of the machine learning model, each small area of a larger map (e.g., in relation to a threshold difference between the two sizes of maps) may be manually labeled as defective or not defective areas (e.g., good/bad, numerical value, etc.). Features from the small areas (such GPS factors residuals) may be labelled accordingly as defective or not defective areas. Those labelled features may be used as input for supervised classifier such as a Decision Tree or a Support Vector Machine. During inference, the trained classifier may be used to predict the label of corresponding features of small areas of a new map. In some examples, a defective area may be identified by the machine learning model as corresponding with a landmark with a confidence value that exceeds a threshold value (e.g., corresponding with an inaccuracy or defectiveness of the geometry map).

At block 360, validation system 330 may generate first crop data or first cropped data (used interchangeably). For example, once validation system 330 identifies the defective areas, validation system 330 may generate the first cropped data that comprises at least one defective area. In some examples, the defective area is drawn as one or more of the polygons overlaid on the geometry map.

At block 362, validation system 330 may provide first cropped data to user device 340. For example, the geometry map and the first cropped data may be transmitted via a communication network between validation system 330 and user device 340. When validation system 330 is implemented at user device 340, an internal communication bus may be used to transfer the data from one internal system to the other at the device. The geometry map and the defective area identified in the first cropped data may be provided to a user interface at a user device.

At block 364, user device 340 may define a bounding box in the geometry map associated with the first cropped data. The bounding box may be received via the user interface to identify an adjustment to the defective area of the geometry map. In some examples, the bounding box is generated by user device 340 using user interface tools to manually draw the bounding box on the geometry map. The user can activate the tool by selecting the tool at the user interface and selecting/clicking on digital locations/points around the map. The bounding box may be enclosed/completed when the user selects the first location/point to close the bounding box.

At block 366, user device 340 may provide bounding box to validation system 330. The bounding box or corresponding adjustment to the defective area of the geometry map may be provided back to validation system 330 as an update/adjustment to the geometry map or machine learning model.

At block 368, validation system 330 may generate second cropped data. The second cropped data may identify a polygon that is different than the first polygon, yet still identify a smaller portion of data than the overall data used to generate the geometry map. Both first cropped data and second cropped data may identify defective areas of the geometry map and correspond with data transfers that are smaller in size than the larger data set associated with the geometry map.

At block 370, validation system 330 may provide second cropped data to user device 340. The second cropped data may include the smaller data set for the user interface.

In some examples, the first cropped data may be associated with user device 340 and the second cropped data may be associated with the multiple bounding boxes generated by a set of user devices. The user devices may access the geometry map and generate the bounding boxes on separate user devices each with a user interface. The bounding boxes may be generated and/or transmitted concurrently to validation system 330.

At block 372, validation system 330 may initiate an action with mapping system 320. For example, validation system 330 may provide the bounding box or corresponding adjustment to the defective area of the geometry map to mapping system 320, which can initiate a retraining of the machine learning model at mapping system 320. The update to the machine learning model may be based on receiving the bounding box from the at least one user device. For example, when the bounding box is received from the user interface, the existence of the bounding box may identify a defect with the map (e.g., the confidence score exceeds a threshold value associated with the machine learning model). Receiving the bounding box may initiate a retraining of the machine learning model to provide more accurate geometry maps that detect/classify landmarks in the environment.

At block 374, validation system 330 may initiate an action with vehicle 310. For example, the action may comprise retrieving additional sensor data from a second vehicle associated with the environment where the first vehicle is located. The additional sensor data may comprise image data that can show a particular portion of the environment in additional detail or from alternative angles. The additional sensor data may be used to update the geometry map for the environment.

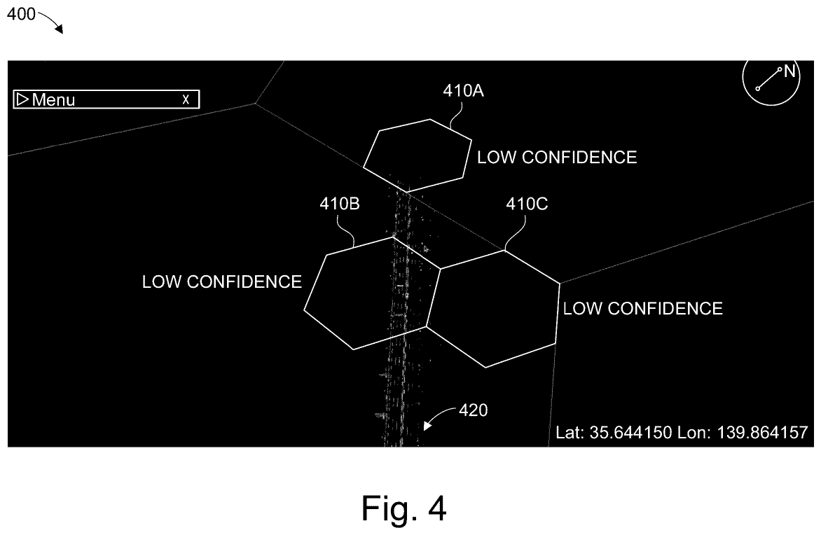

FIG. 4 illustrates an example user interface showing a mapping output, in accordance with some embodiments of the systems and methods described herein. In example 400, geometry map is provided that illustrates an environment from a top-down view of the environment. Three defective areas 410 are illustrated, including first defective area 410A, second defective area 410B, and third defective area 410C. In these defective areas, the validation system may have identified the accuracy of the geometry map to exceed a threshold value and the user device may receive the defective areas and the geometry map (as illustrated) at the user interface.

Landmarks 420 are also provided. For example, the geometry map may use sensor data from the vehicles in the environment to locate landmarks 420 and add them to the geometry map. The vehicle may use the location of landmarks 420 to help determine its current location through data association of the sensor data with the location of the vehicle in the environment. In some examples, landmarks 420 may be inaccurately identified in the geometry map, which the validation system or machine learning model can classify as defective area 410.

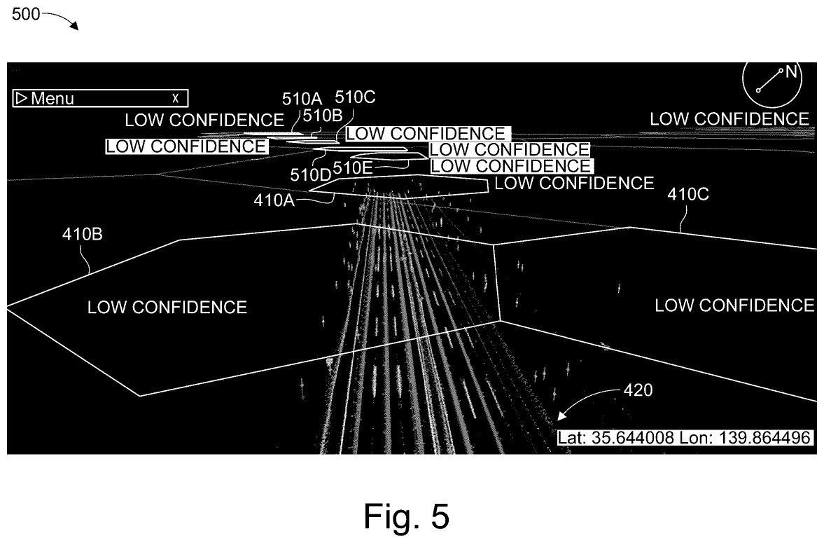

FIG. 5 illustrates an example user interface showing a mapping output, in accordance with some embodiments of the systems and methods described herein. In example 500, geometry map is provided that illustrates an environment from a forward-looking and top-down view of the environment. The original three defective areas 410 are illustrated from FIG. 4, including first defective area 410A, second defective area 410B, and third defective area 410C, with additional defective areas 510 in the background, including fourth defective area 510A, fifth defective area 510B, sixth defective area 510C, seventh defective area 510D, and eighth defective area 510E. In defective areas 410 and 510, the validation system may have identified the accuracy of the geometry map to exceed a threshold value and the user device may receive the defective areas and the geometry map (as illustrated) at the user interface. Landmarks 420 are also repeated from FIG. 4 at a different perspective/view.

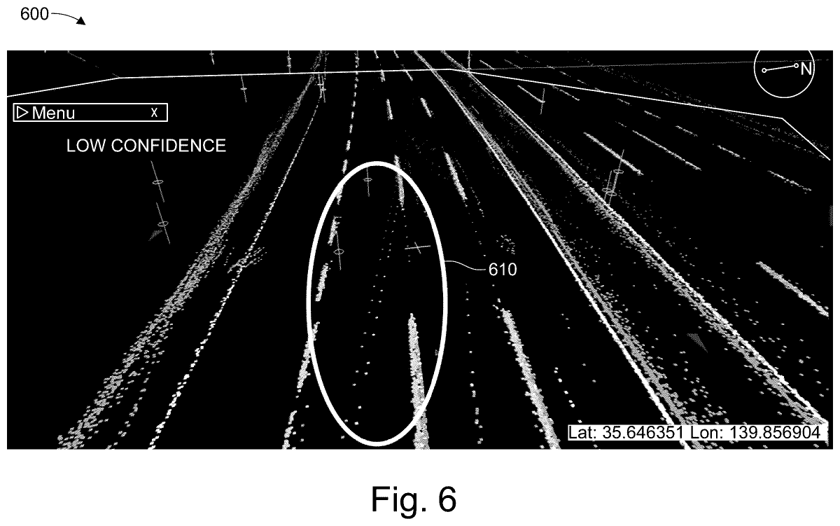

FIG. 6 illustrates an example user interface showing a mapping output, in accordance with some embodiments of the systems and methods described herein. In example 600, an enlarged view of the defective area of the geometry map is provided that illustrates an environment from a forward-looking and top-down view of the environment.

At block 610, the geometry map comprises landmarks that are identified as likely errors in the mapping data. For example, the map may comprise landmarks on a freeway that are identified using sensor data and other data sources. The landmarks on a freeway correspond with landmarks identified by the mapping system, and then identified as likely errors by the validation system in the defective area, based on a comparison with the threshold value.

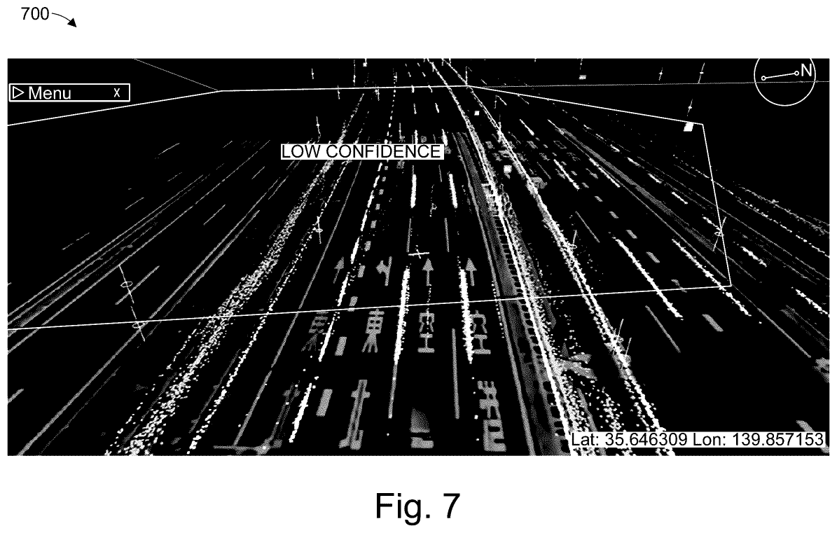

FIG. 7 illustrates an example user interface showing a mapping output, in accordance with some embodiments of the systems and methods described herein. In example 700, an enlarged view of the defective area of the geometry map is provided with an overlay map. The combination of the overlay and the defective area of the geometry map illustrates an environment from a forward-looking and top-down view of the environment.

The overlay may identify images of the environment. The images may include digital photographs of the environment, including roadways, signs, vehicles, or other landmarks that are visible at a particular time.

FIG. 8 illustrates an example user interface showing a bounding box with mapping output, in accordance with some embodiments of the systems and methods described herein. In example 800, bounding box 810 around defective area 820 is illustrated. Bounding box 810 may be generated by the user device using user interface tools 830 to manually draw bounding box 810 on the geometry map. The user can activate user interface tools 830 by selecting the tool at the user interface and selecting/clicking on digital locations/points around the map. Bounding box 810 may be enclosed/completed when the user selects the first location/point to close the bounding box. The bounding box may correspond with a polygon.

Landmarks 820 are also provided. For example, the geometry map may use sensor data from the vehicles in the environment to locate landmarks 820 and add them to the geometry map. In some examples, landmarks 820 may be inaccurately identified in the geometry map, which the validation system or machine learning model can classify as the defective area.

Bounding box 810 may be transmitted from at least one user device, which identifies an adjustment to the defective area of the geometry map. For example, the original defective area may correspond with a six-sided polygon (hexagon) and bounding box may correspond with a five-sided polygon (pentagon), although other shapes and formats may be implemented without diverting from the essence of the disclosure.

Using the defective area of the geometry map identified by the bounding box 810, the validation system may crop the data associated with the defective area of the geometry map, which can generate crop/cropped data. The cropping may help limit the data that is transmitted or reviewed as potentially defective.

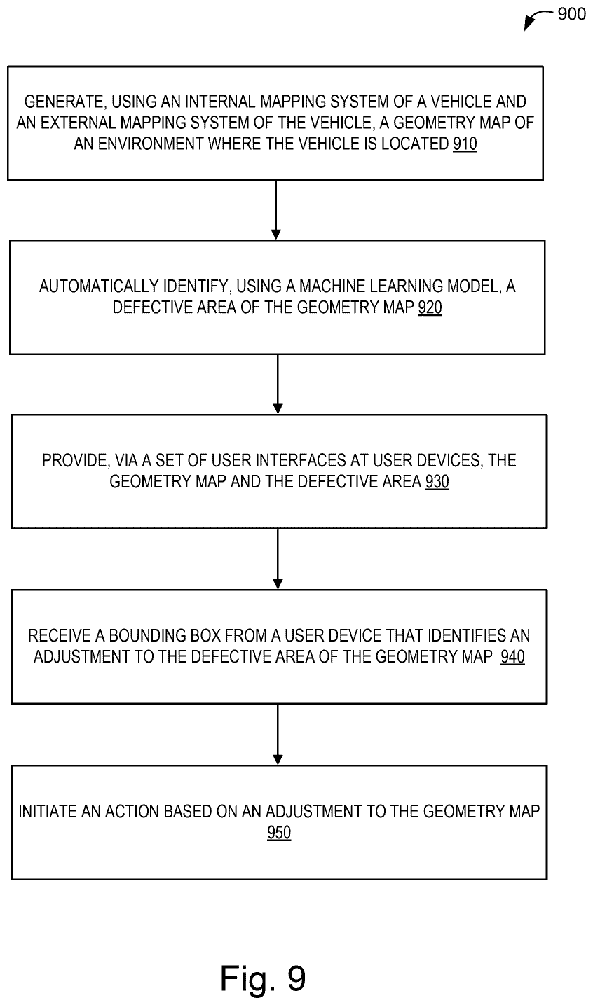

FIG. 9 illustrates a process for validation of mapping output, in accordance with some embodiments of the systems and methods described herein. In example 900, vehicles 100 or 200 with signal modeling circuit 210 illustrated in FIG. 2 may perform various functions described herein. In some examples, the system may perform a series of operations and transmit instructions to vehicles described herein.

At block 910, the process may generate a geometry map of an environment where the vehicle is located. The geometry map may be generated using an internal mapping system of a vehicle and an external mapping system of the vehicle. One method of creating the geometry map is through the use of a Simultaneous Localization and Mapping or “SLAM” system. The SLAM technique is a process of mapping an area while keeping track of the location of the vehicle within that area. In some examples, the vehicle can capture images of the environment and transmit them to the SLAM system, which can generate the geometry map (e.g., offline or remotely at an external SLAM system). The vehicle can use the map to perform localization, including for example, determining its current location and the location of landmarks within the environment.

At block 920, the process may automatically identify a defective area of the geometry map. The defective area that is automatically identified may be identified using a machine learning model. In some examples, the defective area may be identified by the machine learning model as corresponding with a landmark with a confidence value that exceeds a threshold value (e.g., corresponding with an inaccuracy or defectiveness of the geometry map).

At block 930, the process may provide the geometry map and the defective area to a user interface at a user device.

At block 940, the process may receive a bounding box from at least one user device of the user devices. The bounding box may identify an adjustment to the defective area of the geometry map. In some examples, a human user may identify the dimensions of the bounding box. The bounding box may be generated by the user device using user interface tools to manually draw the bounding box on the geometry map. The user can activate the tool by selecting the tool at the user interface and selecting/clicking on digital locations/points around the map. The bounding box may be enclosed/completed when the user selects the first location/point to close the bounding box.

In some examples, the bounding box may be used to crop the defective area of the geometry map based on the bounding box. For example, the bounding box may identify an adjustment to a defective area of the geometry map, which the system can use to limit the data that is transmitted or identified for adjustment.

At block 950, the process may initiate an action based on the adjustment to the defective area of the geometry map. For example, the action may comprise retrieving additional sensor data from a second vehicle associated with the environment where the first vehicle is located. The additional sensor data may comprise image data that can show a particular portion of the environment in additional detail or from alternative angles. The additional sensor data may be used to update the geometry map for the environment. In other examples, the machine learning model may be retrained with new/different sensor data.

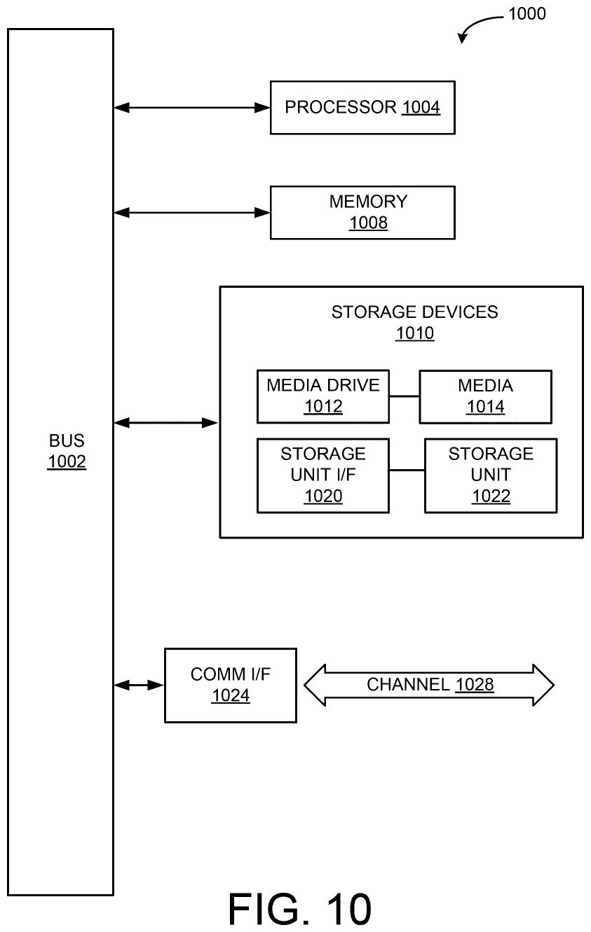

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 10. Various embodiments are described in terms of this example-computing component 1000. After reading this description, it will become apparent to a person skilled in the relevant art how to implement the application using other computing components or architectures.

Referring now to FIG. 10, computing component 1000 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1000 might also represent computing capabilities embedded within or otherwise available to a given device. For example, a computing component might be found in other electronic devices such as, for example, portable computing devices, and other electronic devices that might include some form of processing capability.

Computing component 1000 might include, for example, one or more processors, controllers, control components, or other processing devices. This can include a processor, and/or any one or more of the components making up a user device, a user system, and a non-decrypting cloud service. Processor 1004 might be implemented using a general-purpose or special-purpose processing engine such as, for example, a microprocessor, controller, or other control logic. Processor 1004 may be connected to a bus 1002. However, any communication medium can be used to facilitate interaction with other components of computing component 1000 or to communicate externally.

Computing component 1000 might also include one or more memory components, simply referred to herein as main memory 1008. For example, random access memory (RAM) or other dynamic memory, might be used for storing information and instructions to be executed by processor 1004. Main memory 1008 might also be used for storing temporary variables or other intermediate information during execution of instructions to be executed by processor 1004. Computing component 1000 might likewise include a read only memory (“ROM”) or other static storage device coupled to bus 1002 for storing static information and instructions for processor 1004.

The computing component 1000 might also include one or more various forms of information storage mechanism 1010, which might include, for example, a media drive 1012 and a storage unit interface 1020. The media drive 1012 might include a drive or other mechanism to support fixed or removable storage media 1014. For example, a hard disk drive, a solid-state drive, a magnetic tape drive, an optical drive, a compact disc (CD) or digital video disc (DVD) drive (R or RW), or other removable or fixed media drive might be provided. Storage media 1014 might include, for example, a hard disk, an integrated circuit assembly, magnetic tape, cartridge, optical disk, a CD or DVD. Storage media 1014 may be any other fixed or removable medium that is read by, written to or accessed by media drive 1012. As these examples illustrate, the storage media 1014 can include a computer usable storage medium having stored therein computer software or data.

In alternative embodiments, information storage mechanism 1010 might include other similar instrumentalities for allowing computer programs or other instructions or data to be loaded into computing component 1000. Such instrumentalities might include, for example, a fixed or removable storage unit 1022 and interface 1020. Examples of such storage units 1022 and interfaces 1020 can include a program cartridge and cartridge interface, a removable memory (for example, a flash memory or other removable memory component) and memory slot. Other examples may include a PCMCIA slot and card, and other fixed or removable storage units 1022 and interfaces 1020 that allow software and data to be transferred from storage unit 1022 to computing component 1000.

Computing component 1000 might also include a communications interface 1024. Communications interface 1024 might be used to allow software and data to be transferred between computing component 1000 and external devices. Examples of communications interface 1024 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 1024 may be carried on signals, which can be electronic, electromagnetic (which includes optical) or other signals capable of being exchanged by a given communications interface 1024. These signals might be provided to communications interface 1024 via a channel 1028. Channel 1028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1008, storage unit 1020, media 1014, and channel 1028. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1000 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
a memory; and
a processor that is configured to execute machine readable instructions stored in the memory for causing the processor to:
generate, using an internal mapping system of a vehicle and an external mapping system of the vehicle, a geometry map of an environment where the vehicle is located;
automatically identify, using a machine learning model, a defective area of the geometry map;
provide, via a user interface at a user device, the geometry map and the defective area;
receive a bounding box from at least one user device of the user devices, wherein the bounding box identifies an adjustment to the defective area of the geometry map;
crop the defective area of the geometry map based on the bounding box; and
initiate an action based on the adjustment to the defective area of the geometry map.

2. The system of claim 1, wherein the vehicle is a first vehicle, and the action comprises:
retrieving sensor data from a second vehicle associated with the environment where the first vehicle is located.

3. The system of claim 1, wherein the action comprises:
retraining the machine learning model based on receiving the bounding box from the at least one user device.

4. The system of claim 1, wherein the defective area is drawn as a polygon overlaid on the geometry map, and wherein both the polygon and the geometry map are provided to the user interface.

5. The system of claim 4, wherein the defective area is a three-dimensional object and the polygon is a two-dimensional object.

6. The system of claim 1, wherein the geometry map is drawn with a first set of polygons and the defective area is drawn with a second polygon that differs from the first set of polygons.

7. The system of claim 1, wherein the bounding box is a first bounding box received from the user device, and wherein the first bounding box is received concurrently with a second bounding box from a second user device.

8. The system of claim 1, wherein the internal mapping system of the vehicle receives sensor data from sensors in the vehicle used to generate the geometry map of the environment.

9. The system of claim 1, wherein the external mapping system of the vehicle is a Simultaneous Localization and Mapping (SLAM) system.

10. The system of claim 1, wherein the machine learning model is a classifier implemented by a supervised machine learning model.

11. A method comprising:
generating, using an internal mapping system of a vehicle and an external mapping system of the vehicle, a geometry map of an environment where the vehicle is located;
automatically identifying, using a machine learning model, a defective area of the geometry map;
providing, via a user interface at a user device, the geometry map and the defective area;
receiving a bounding box from at least one user device of the user devices, wherein the bounding box identifies an adjustment to the defective area of the geometry map;
cropping the defective area of the geometry map based on the bounding box; and
initiating an action based on the adjustment to the defective area of the geometry map.

12. The method of claim 11, wherein the vehicle is a first vehicle, and the action comprises:
retrieving sensor data from a second vehicle associated with the environment where the first vehicle is located.

13. The method of claim 11, wherein the action comprises:
retraining the machine learning model based on receiving the bounding box from the at least one user device.

14. The method of claim 11, wherein the defective area is drawn as a polygon overlaid on the geometry map, and wherein both the polygon and the geometry map are provided to the user interface.

15. The method of claim 14, wherein the defective area is a three-dimensional object and the polygon is a two-dimensional object.

16. The method of claim 11, wherein the geometry map is drawn with a first set of polygons and the defective area is drawn with a second polygon that differs from the first set of polygons.

17. The method of claim 11, wherein the bounding box is a first bounding box received from the user device, and wherein the first bounding box is received concurrently with a second bounding box from a second user device.

18. The method of claim 11, wherein the internal mapping system of the vehicle receives sensor data from sensors in the vehicle used to generate the geometry map of the environment.

19. The method of claim 11, wherein the external mapping system of the vehicle is a Simultaneous Localization and Mapping (SLAM) system.

20. The method of claim 11, wherein the machine learning model is a classifier implemented by a supervised machine learning model.
